(19) United States
(12) Patent Application Publication
(10) Pub. No.: US 2010/0080891 A1
(43) Pub. Date: Apr. 1, 2010

(54) HOLDING MECHANISM, PROCESSING APPARATUS INCLUDING HOLDING MECHANISM, DEPOSITION METHOD USING PROCESSING APPARATUS, AND METHOD OF MANUFACTURING IMAGE DISPLAY DEVICE

(75) Inventors: Masanao YOSHIMURA, Ebina-shi (JP); Shoji Hashimoto, Kawasaki-shi (JP); Masato Inoue, Chigasaki-shi (JP); Shin Matsui, Fujisawa-shi (JP)

Correspondence Address: BUCHANAN, INGERSOLL & ROONEY PC, POST OFFICE BOX 1404, ALEXANDRIA, VA, 22313-1404, US

(73) Assignee: CANON ANELVA CORPORATION, Kawasaki-shi (JP)

(21) Appl. No.: 12/568,031

(22) Filed: Sep. 28, 2009

(30) Foreign Application Priority Data
Sep. 30, 2008 (JP) 2008-255178

(51) Int. Cl. B05D 5/06; B05D 3/00; B05C 13/00

(52) U.S. Cl. 427/64; 427/282; 118/500

(57) ABSTRACT

The present invention provides a holding mechanism which holds a processing object and a mask including a mask pattern located on the processing object, and a mask frame which supports the mask pattern in a periphery thereof, the mechanism including a base configured to hold, on a holding surface thereof, the processing object and the mask frame, a permanent magnet, arranged along the holding surface of the base, configured to fix the processing object and the mask on the base by magnetically attracting the mask, and a pressing unit which is located on a peripheral portion of the mask pattern, includes a to-be-attracted portion magnetically attracted by the permanent magnet, and is configured to press the peripheral portion of the mask pattern toward the base as the permanent magnet magnetically attracts the to-be-attracted portion.

### BACKGROUND OF THE INVENTION

1. Field of the Invention

The present invention relates to a holding mechanism, a processing apparatus including the holding mechanism, a deposition method using the processing apparatus, and a method of manufacturing an image display device.

2. Description of the Related Art

One commonly-used manufacturing apparatus which manufactures an image display device is a processing apparatus which forms a desired pattern on a substrate (glass substrate) for a flat panel display, typified by an organic electroluminescent element, with a desired accuracy (i.e., which imparts a desired function to an image display device). This processing apparatus forms a pattern on a substrate using, for example, a vacuum deposition, sputtering, photolithography, or screen printing method. To keep up with the recent demand for a higher-resolution display capability of image display devices, it is necessary to form a finer pattern with high accuracy.

A vacuum deposition method is known to allow the formation of a finer pattern with low cost and high reliability, like a sputtering method, as compared with the other methods (see Japanese Patent Publication No. 6-51905). Especially in the manufacture of a display which employs an organic electroluminescent element as a display element, a vacuum deposition method is attracting attention as a dry process which almost eliminates moisture damage to an element being manufactured, that can occur in wet processes typified by a photolithography method.

A vacuum deposition method forms a pattern on a substrate as a processing object by bringing a mask having an opening corresponding to the pattern into tight contact with the surface of the substrate, and depositing a material on the substrate through the mask. In a vacuum deposition method, the precision of a pattern formed on a substrate depends on that of a mask. Under the circumstance, various kinds of techniques for forming a fine pattern (opening) on a mask with high accuracy have been proposed in the vacuum deposition method (see Japanese Patent Laid-Open No. 10-41069).

To form a fine pattern on a mask, the mask needs to have a relatively small thickness. To ensure a given pattern precision of a mask, the mask also needs to have a given tightness of contact with a substrate and a flatness good enough to prevent the mask from suffering, for example, any flexure and wrinkles.

To meet these requirements, there is proposed a technique which fixes (welds) the periphery of a metallic mask, having a thickness of 500 μm or less, on a mask frame while applying a tension to the mask (see Japanese Patent No. 3539125). Japanese Patent No. 3539125 can ensure a given mask flatness because a tension always acts on the mask. Note, however, that the mask frame needs to have high rigidity because the mask frame (its rigidity) must stand a reaction force to the tension acting on the mask. If the mask frame has low rigidity, the mask frame itself deforms by the reaction force, so the tension acting on the mask reduces. This makes it impossible to ensure a given mask flatness.

In this manner, ensuring a given pattern precision requires high rigidity of a mask frame, and this means that the weight of a metallic mask inevitably increases. Furthermore, as the size of a substrate (processing object) increases and a technique for producing a large number of devices per substrate advances in order to improve the processing capability, the size of a mask also increases. This, in turn, increases the weight of a mask. Along with this trend, a mask holding mechanism is required to hold (fix) a heavy mask free from any positional error, and ensure a given tightness of contact between the mask and the substrate.

To improve the processing capability, a processing apparatus which adopts an improved substrate transport scheme has been proposed (see Japanese Patent Laid-Open No. 2002-203885). Japanese Patent Laid-Open No. 2002-203885 proposes a processing apparatus which adopts, for example, a transport scheme called the in-line scheme or that called the inter-back scheme as an improved version of the in-line scheme. The in-line scheme and the inter-back scheme generally use roller transportation as a substrate transport unit, and therefore require a substrate holding mechanism (transport carrier) to hold (fix) a substrate. The substrate holding mechanism is required to hold a substrate free from any positional error during its transportation, to prevent the transport roller and the substrate from coming into direct contact with each other, and to shield (mask) a portion (the peripheral portion of the substrate) other than the pattern formation region on the substrate.

It is a common practice to mechanically fix the peripheral portion of a substrate in a substrate holding mechanism of the in-line scheme or the inter-back scheme, as described in Japanese Patent Laid-Open No. 2002-203885. However, as the size of a substrate increases and the required pattern precision improves, the requirement for suppressing (preventing) any flexure and positional error of the substrate grows. In response to this requirement, the use of an electrostatic chuck which holds (electrostatically attracts) a semiconductor wafer substrate has been proposed (see Japanese Patent Laid-Open Nos. 8-51137 and 8-83832).

As described above, to form a pattern using a vacuum deposition method, it is also necessary to hold (fix) a substrate and a mask free from any positional errors. In this case, there is proposed a technique which holds a substrate and a mask without using an electrostatic chuck.

FIGS. 7A and 7B are views illustrating an example of the arrangement of a holding mechanism 1000 which holds a substrate and a mask using permanent electromagnets. The permanent electromagnet means herein one which can implement an attracting state, in which a holding object (substrate) is magnetically attracted, and a non-attracting state, in which the holding object is not magnetically attracted, by external electrical control between states in which the magnetic field of the permanent electromagnet leaks and does not leak outside the permanent electromagnet. Hence, the permanent electromagnet used herein is not limited to the arrangement shown in FIGS. 7A and 7B, and is incorporated in the one referred to in this specification as long as its arrangement can implement the above-mentioned function.

The operation of the holding mechanism 1000 will be explained with reference to FIGS. 7A and 7B. In FIGS. 7A and 7B, reference numeral 1010 denotes a magnetic body, reference numeral 1020 denotes a fixed-polarity magnet, reference numeral 1030 denotes a variable-polarity magnet, reference numeral 1040 denotes a coil, reference numeral 1050 denotes a magnet fixing component, and reference numeral 1060 denotes a space to accommodate wiring for supplying a current to the coil 1040. Also, reference symbol L denotes a magnetic line of force from the fixed-polarity magnet 1020, and reference symbol N and S denote magnetic poles.

FIG. 7A shows an attracting state in which a mask made of a magnetic body is magnetically attracted. More specifically, the polarity of the variable-polarity magnet 1030 is reversed by supplying a current to the coil 1040 for about 0.5 sec so that the fixed-polarity magnet 1020 and the variable-polarity magnet 1030 become homopolar. With this operation, a large amount of magnetic field (magnetic lines of force L) from the fixed-polarity magnet 1020 leaks outside the holding mechanism 1000. Thus, the magnetic body 1010 can magnetically attract the mask.

FIG. 7B shows a non-attracting state in which a mask made of a magnetic body is not magnetically attracted. More specifically, the polarity of the variable-polarity magnet 1030 is reversed by supplying a current to the coil 1040 for about 0.5 sec so that the fixed-polarity magnet 1020 and the variable-polarity magnet 1030 attract each other. With this operation, the magnetic field (the magnetic lines of force L) from the fixed-polarity magnet 1020 is inhibited from leaking outside the holding mechanism 1000. Thus, the magnetic body 1010 and the mask do not attract each other.

FIGS. 8A to 8D are views for explaining the procedure from alignment between a mask and a substrate (processing object) to their holding (fixing) in a processing apparatus. In FIGS. 8A to 8D, reference numeral 2010 denotes a mask, reference numeral 2020 denotes a substrate, reference numeral 2030 denotes a base which holds the mask 2010 and the substrate 2020, and reference numeral 2040 denotes a permanent electromagnet. The mask 2010 includes a mask pattern (mask membranous plane (membrane)) 2012 having an opening, and a mask frame 2014. Permanent electromagnets 2040 indicated by white are in a non-attracting state, and those indicated by shaded regions are in an attracting state.

FIG. 8A shows a state in which the mask 2010 and the substrate 2020 are aligned. In this case, the substrate 2020 is located on the base 2030, and the mask 2010 is positioned on the substrate 2020. In the state shown in FIG. 8A, the relative position between the mask 2010 and the substrate 2020 needs to fall within the range of a predetermined accuracy (i.e., they need to be aligned). Alignment between the mask 2010 and the substrate 2020 is implemented by, for example, moving the mask 2010 or the substrate 2020 while observing alignment marks, formed in predetermined portions on the mask 2010 and substrate 2020, using a CCD camera or the like. If the mask 2010 and the substrate 2020 are in contact with each other during their relative movement, the substrate 2020 may be flawed. To avoid this, the mask 2010 and the substrate 2020 are prevented from coming into contact with each other by setting a predetermined spacing between them, as shown in FIG. 8A. However, an excessive spacing between the mask 2010 and the substrate 2020 accounts for positional errors upon fixing the mask 2010 and the substrate 2020 while they are in tight contact with each other. Hence, the spacing between the mask 2010 and the substrate 2020 is desirably as small as possible and is, for example, 500 μm or less.

FIG. 8B shows a state in which the mask frame 2014 is fixed by activating only permanent electromagnets 2040a which magnetically attract the mask frame 2014 after the end of alignment between the mask 2010 and the substrate 2020. Note that a power supply for activating the permanent electromagnets 2040a which magnetically attract the mask frame 2014, and that for activating permanent electromagnets 2040b and 2040c which magnetically attract the mask pattern 2012 operate independently of each other. In the state shown in FIG. 8B, only the mask frame 2014 is fixed on the base 2030 by magnetic attraction of the permanent electromagnets 2040a, and a predetermined spacing is formed between the mask pattern 2012 and the substrate 2020. Hence, this operation does not cause any positional error between the mask 2010 and the substrate 2020.

FIG. 8C shows a state in which only the permanent electromagnets 2040b which magnetically attract the central portion of the mask pattern 2012 are activated after the mask frame 2014 is fixed on the base 2030. Referring to FIG. 8C, the central portion of the mask pattern 2012 elastically deforms upon magnetic attraction of the permanent electromagnets 2040b, and is in contact with that of the substrate 2020. Since the central portion of the mask pattern 2012 is in contact with that of the substrate 2020 while being applied with a tension, the occurrences of any positional error and wrinkles of the mask 2010 are suppressed as compared with a case in which the entire surface of the mask pattern 2012 is magnetically attracted at once. This makes it possible to ensure good tightness of contact.

FIG. 8D shows a state in which only the permanent electromagnets 2040c which magnetically attract the peripheral portion of the mask pattern 2012 are activated after the central portions of the mask pattern 2012 and substrate 2020 come into contact with each other. Referring to FIG. 8D, the peripheral portion of the mask pattern 2012 elastically deforms upon magnetic attraction of the permanent electromagnets 2040c, and is in contact with that of the substrate 2020. In this state, the entire surfaces of the mask pattern 2012 and substrate 2020 are in contact with each other. The permanent electromagnets 2040b and 2040c which magnetically attract the mask pattern 2012 are located so as to apply a uniform attraction force to the mask pattern 2012. More specifically, the permanent electromagnets 2040b and 2040c are equidistantly disposed in a plane facing the mask pattern 2012.

In this way, the mask pattern 2012 and the substrate 2020 come into tight contact with each other. In addition, the substrate 2020 is fixed on the base 2030 when pressed against the base 2030 by the mask pattern 2012. Hence, the substrate 2020 can be fixed on the base 2030 even when the substrate 2020 is a nonmagnetic body (e.g., a glass substrate).

Techniques associated with holding (fixing) of a substrate (processing object) using an electrostatic chuck, which have been proposed in Japanese Patent Laid-Open Nos. 8-51137 and 8-83832, pose the following problems. The substrate used herein is typically a glass substrate, which is an insulator having a high volume resistivity to disable an electrostatic chuck to electrostatically attract it at room temperature. For this reason, holding a glass substrate using an electrostatic chuck requires a heating/cooling mechanism for decreasing the volume resistivity of the glass substrate. Also, the use of a unipolar electrostatic chuck requires imparting a property which allows electrostatic attraction to a glass substrate by applying a conductive film on the glass substrate. Therefore, Japanese Patent Laid-Open Nos. 8-51137 and 8-83832 undesirably increase the product cost and the apparatus take time and cost. Furthermore, when it is necessary to hold (fix) not only a substrate but also a mask, this requires a holding mechanism, other than an electrostatic chuck, such as permanent magnets and permanent electromagnets, leading to a further increase in apparatus cost.

Recently, there arises another problem. In the conventional techniques, a substrate is fixed by magnetic attraction for only a mask, and a positional error of the substrate occurs owing to acceleration/deceleration in the process of transporting the substrate and the mask, and adversely affects the precision of a pattern formed on the substrate. This problem is conspicuous especially, for example, when the mask has a small thickness, when the substrate has a large thickness (i.e., when the substrate has a small mass per unit area), or when the mask and the permanent electromagnets have a long distance between them.

### SUMMARY OF THE INVENTION

The present invention provides a technique which can suppress any positional error of a processing object (substrate) when the processing object is held using a permanent electromagnet.

According to one aspect of the present invention, there is provided a holding mechanism which holds a processing object and a mask including a mask pattern located on the processing object, and a mask frame which supports the mask pattern in a periphery thereof, the mechanism including a base configured to hold, on a holding surface thereof, the processing object and the mask frame, a permanent magnet, arranged along the holding surface of the base, configured to fix the processing object and the mask on the base by magnetically attracting the mask, and a pressing unit which is located on a peripheral portion of the mask pattern, includes a to-be-attracted portion magnetically attracted by the permanent magnet, and is configured to press the peripheral portion of the mask pattern toward the base as the permanent magnet magnetically attracts the to-be-attracted portion.

According to second aspect of the present invention, there is provided a processing apparatus including a holding mechanism configured to hold a processing object and a mask including a mask pattern located on the processing object, and a mask frame which supports the mask pattern in a periphery thereof, a processing unit configured to process the processing object through the mask, and a transport unit configured to transport the holding mechanism to the processing unit, wherein the holding mechanism includes the above holding mechanism.

According to third aspect of the present invention, there is provided a deposition method including forming a thin film on a processing object using the above processing apparatus.

According to fourth aspect of the present invention, there is provided a method of manufacturing an image display device, the method including manufacturing a luminescent portion from the processing object having the thin film formed using the above deposition method.

Further features of the present invention will become apparent from the following description of exemplary embodiments with reference to the attached drawings.

### BRIEF DESCRIPTION OF THE DRAWINGS

FIG. 1 is a schematic sectional view showing the arrangement of a holding mechanism according to one aspect of the present invention.

FIG. 2 is a schematic sectional view illustrating an example of the arrangement of a permanent electromagnet shown in FIG. 1.

FIG. 3 is a schematic plan view illustrating an example of the arrangement of a mask shown in FIG. 1.

FIGS. 4A and 4B are enlarged views showing a pressing unit of the holding mechanism shown in FIG. 1 and its vicinity.

FIGS. 5A and 5B are enlarged views showing another pressing unit of the holding mechanism shown in FIG. 1 and its vicinity.

FIG. 6 is a schematic view showing a deposition process using a processing apparatus according to the present invention.

FIGS. 7A and 7B are views illustrating an example of the arrangement of a holding mechanism.

FIGS. 8A to 8D are views for explaining the procedure from alignment between a mask and a substrate (processing object) to their holding (fixing) in a processing apparatus.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

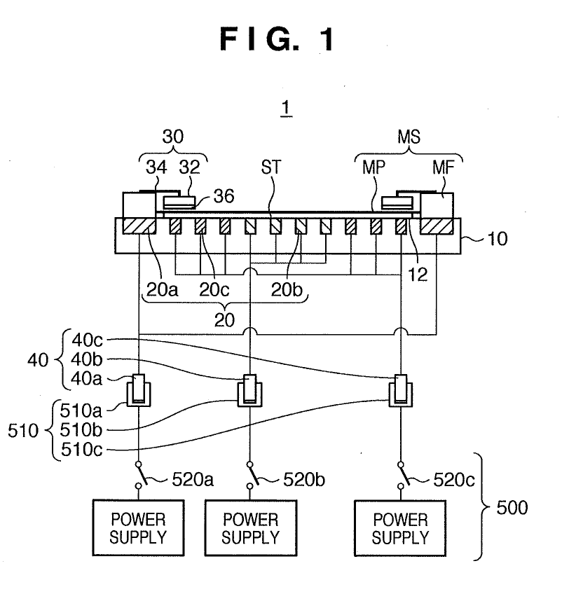

FIG. 1 is a schematic sectional view showing the arrangement of a holding mechanism 1 according to one aspect of the present invention. The holding mechanism 1 holds (fixes) a mask and a substrate as a processing object. The holding mechanism 1 is suitable for holding (fixing) a substrate and a mask upon aligning them in a processing apparatus which adopts, for example, the in-line scheme or the inter-back scheme and forms a pattern on a substrate as a processing object by depositing a material on the substrate. Note that FIG. 1 shows a state in which alignment between a substrate (processing object) ST and a mask MS is complete.

Referring to FIG. 1, the substrate ST is held on a holding surface 12 of a base 10, and the mask MS is located on the substrate ST. Details of the mask MS are as follows. A mask pattern (mask membranous plane) MP of the mask MS is located so as to cover the substrate ST, and a mask frame MF which supports the mask pattern MP in its periphery is held on the holding surface 12 of the base 10. Also, permanent electromagnets 20 which fix the mask MS on the base 10 by magnetic attraction are arranged along the holding surface 12 of the base 10. The permanent electromagnets 20 include permanent electromagnets 20a for magnetically attracting the mask frame MF, permanent electromagnets 20b for magnetically attracting the central portion of the mask pattern MP, and permanent electromagnets 20c for magnetically attracting the peripheral portion of the mask pattern MP. The permanent electromagnets 20b and 20c are located to be able to uniformly magnetically attract the mask pattern MP.

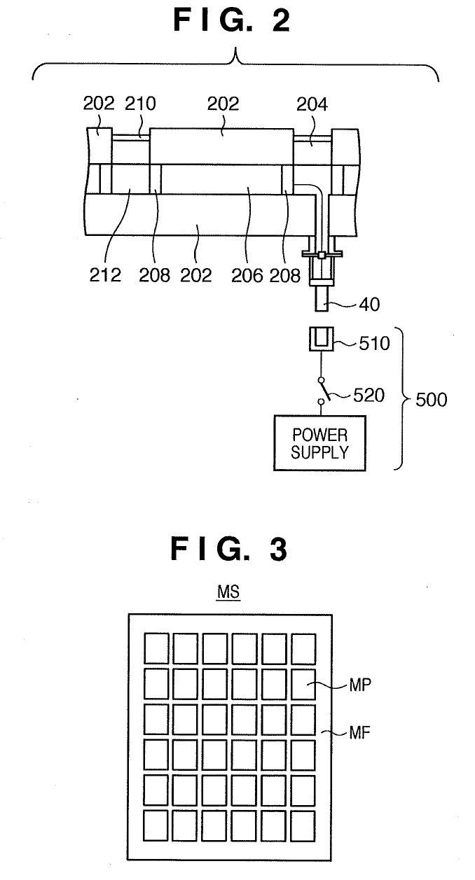

The permanent electromagnets 20 can take any form known to those skilled in the art. The permanent electromagnet 20 includes, for example, a magnetic body 202, a fixed-polarity magnet 204, a variable-polarity magnet 206, a coil 208, a magnet fixing component 210, and a space 212 to accommodate wiring for supplying a current to the coil 208, as shown in FIG. 2. Note that FIG. 2 is a schematic sectional view illustrating an example of the arrangement of the permanent electromagnet 20.

The mask MS includes the mask pattern MP having a minute opening (pattern) to form a pattern (thin-film pattern) on the processing target surface of the substrate ST, and the mask frame MF having high rigidity, as shown in FIG. 3. The mask pattern MP and the mask frame MF are made of a magnetic material (e.g., a metallic magnetic material such as iron). Moreover, the mask pattern MP and the mask frame MF are made of a low-thermal expansion material such as an Invar material in order to suppress thermal expansion attributed to radiation heat generated during a deposition process. The minute opening of the mask pattern MP is formed using a method such as etching. Note that FIG. 3 is a schematic plan view illustrating an example of the arrangement of the mask MS.

As the thickness of the mask pattern MP increases, the thickness in a region where the minute opening is formed decreases undesirably. From this viewpoint, the thickness of the mask pattern MP is smaller than that of the mask frame MF and is, for example, 0.05 mm or less. Setting the thickness of the mask pattern MP small allows a material (particles), which is supplied from a deposition source and obliquely enters the minute opening, to reach the substrate ST. The mask pattern MP is fixed on the mask frame MF, while being applied with a tension, using a method such as welding.

A pressing unit 30 is located on the peripheral portion of the mask pattern MP as shown in FIG. 1, and includes an elastic member 34 which connects to the mask frame MF in this embodiment. The elastic member 34 includes, for example, a leaf spring made of a nonmagnetic material.

The pressing unit 30 presses the mask pattern MP toward the base 10 in a region, where the opening (pattern) of the mask pattern MP is absent, when magnetically attracted by the permanent electromagnets 20c. A to-be-attracted portion 32 can be located so as to surround the periphery of the substrate ST (mask pattern MP) over an area that falls within the range in which the to-be-attracted portion 32 does not disturb processing (i.e., the function of the processing apparatus) for the substrate ST.

In this embodiment, the to-be-attracted portion 32 is configured such that the magnetic attraction force of the permanent electromagnets 20c for the to-be-attracted portion 32 is larger than that of the permanent electromagnets 20b and 20c for the mask pattern MP. When, for example, the pressing unit 30 and the mask pattern MP are made of the same material, the to-be-attracted portion 32 is configured such that the pressing unit 30 has a thickness larger than that of the mask pattern MP. With this arrangement, the mass of the to-be-attracted portion 32 per unit area is relatively large. Thus, the magnetic attraction force of the permanent electromagnets 20c for the to-be-attracted portion 32 is larger than that of the permanent electromagnets 20b and 20c for the mask pattern MP.

Although the to-be-attracted portion 32 has a cubic shape in this embodiment, the present invention is not limited to this. The to-be-attracted portion 32 may have any shape such as a dome shape as long as its surface (region) having a predetermined area or more comes into contact with the mask pattern MP upon magnetically attracting the to-be-attracted portion 32 by the permanent electromagnets 20c.

Also, the to-be-attracted portion 32 includes, on its contact surface that comes into contact with the mask pattern MP, a protective member 36 which protects the mask pattern MP. The protective member 36 is made of, for example, a rubber sheet and prevents the mask pattern MP from damaging due to an impact as the to-be-attracted portion 32 presses the mask pattern MP when magnetically attracted by the permanent electromagnets 20c.

Details of holding (fixing) of the substrate ST and mask MS by magnetic attraction in the holding mechanism 1 will be explained herein. The holding mechanism 1 can be transported by a transport mechanism (not shown), and is transported to a stop position at which a power feed system 500 is set (e.g., a predetermined stop position in the processing apparatus), as shown in FIG. 1.

At the stop position of the holding mechanism 1, base-side contacts 40 of the holding mechanism 1 are connected to power-supply-side contacts 510 of the power feed system 500. A driving mechanism (not shown) can easily implement the connection between the base-side contacts 40 and the power-supply-side contacts 510. Although high-current fitting pins are used as the base-side contacts 40 and the power-supply-side contacts 510 in this embodiment, high-current probes can also be used.

The base-side contacts 40 include base-side contacts 40a, 40b, and 40c in order to independently activate the permanent electromagnets 20a, 20b, and 20c, respectively. The power-supply-side contacts 510 include power-supply-side contacts 510a, 510b, and 510c in one-to-one correspondence with the base-side contacts 40a, 40b, and 40c.

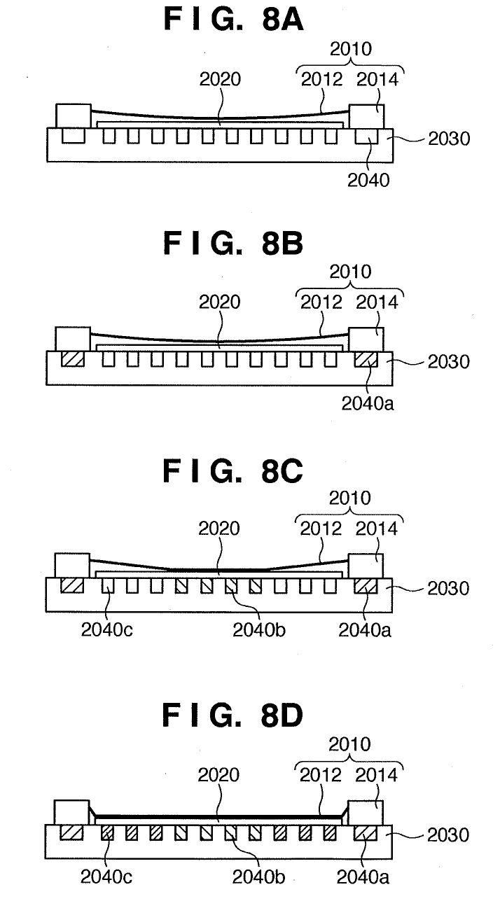

While the base-side contacts 40 and the power-supply-side contacts 510 are connected to each other, switches 520a, 520b, and 520c are sequentially energized to supply a current to the permanent electromagnets 20a, 20b, and 20c, respectively. This allows the permanent electromagnets 20a, 20b, and 20c to magnetically attract the mask MS (the mask frame MF and the mask pattern MP), thereby fixing the substrate ST on the base 10 through the mask MS. At this time, the permanent electromagnets 20c also magnetically attract the to-be-attracted portion 32 of the pressing unit 30. Hence, the substrate ST is fixed on the base 10 when pressed against the base 10 by the magnetic attraction force of the permanent electromagnets 20b and 20c for the mask pattern MP, and that of the permanent electromagnets 20c for the to-be-attracted portion 32. The order in which the permanent electromagnets 20a, 20b, and 20c magnetically attract the mask MS is the same as that described with reference to FIGS. 8A to 8D, and a detailed description thereof will not be given herein.

In this manner, the holding mechanism 1 exploits not only the magnetic attraction force for the mask pattern MP but also that to the to-be-attracted portion 32. This makes it possible to fix the substrate ST more strongly than in the conventional techniques, and, in turn, to suppress any positional error of the substrate ST.

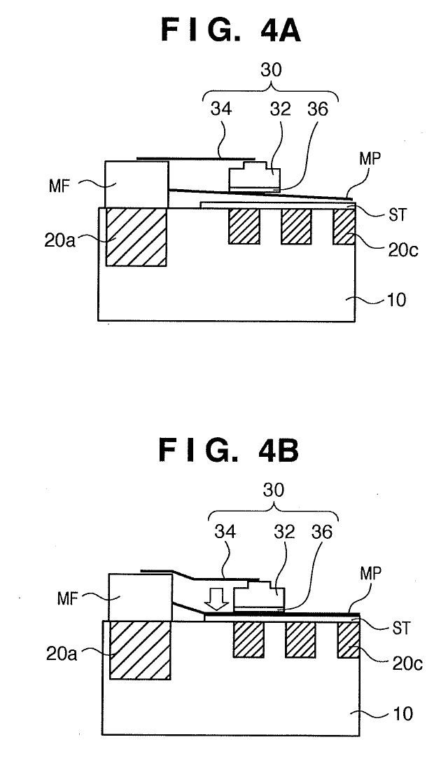

The operation of the holding mechanism 1 and, in particular, the detailed operation of the pressing unit 30 will be explained with reference to FIGS. 4A and 4B. FIGS. 4A and 4B are enlarged views showing the pressing unit 30 of the holding mechanism 1 and its vicinity.

FIG. 4A shows a state before the to-be-attracted portion 32 of the pressing unit 30 is magnetically attracted, that is, a state in which the permanent electromagnets 20a magnetically attract the mask frame MF, and the permanent electromagnets 20b magnetically attract the central portion of the mask pattern MP. In the state shown in FIG. 4A, the permanent electromagnets 20c for magnetically attracting the peripheral portion of the mask pattern MP are inactive (i.e., they are not supplied with a current), and therefore do not magnetically attract the peripheral portion of the mask pattern MP. For this reason, the substrate ST and the peripheral portion of the mask pattern MP are spaced apart from each other. The mask pattern MP and the to-be-attracted portion 32 (protective member 36) are also spaced apart from each other by the elastic member 34 which connects the mask frame MF and the to-be-attracted portion 32 of the pressing unit 30.

In the state shown in FIG. 4A, as the permanent electromagnets 20c are activated upon receiving a current, they magnetically attract the to-be-attracted portion 32 and the peripheral portion of the mask pattern MP. With this operation, the peripheral portion of the mask pattern MP presses the substrate ST toward the base 10, and the to-be-attracted portion 32 presses the peripheral portions of the mask pattern MP and substrate ST toward the base 10, as shown in FIG. 4B. At the same time, the elastic member 34 deforms due to a force generated upon magnetically attracting the to-be-attracted portion 32. The substrate ST is satisfactorily fixed on the base 10 because the to-be-attracted portion 32 is configured such that the magnetic attraction force of the permanent electromagnets 20c for the to-be-attracted portion 32 is larger than that of the permanent electromagnets 20b and 20c for the mask pattern MP, as described above. Consequently, a given precision of a pattern formed on the substrate ST, for example, can be maintained free from any positional error of the substrate ST attributed to acceleration/deceleration even upon transporting the holding mechanism 1 which holds (fixes) the substrate ST and the mask MS.

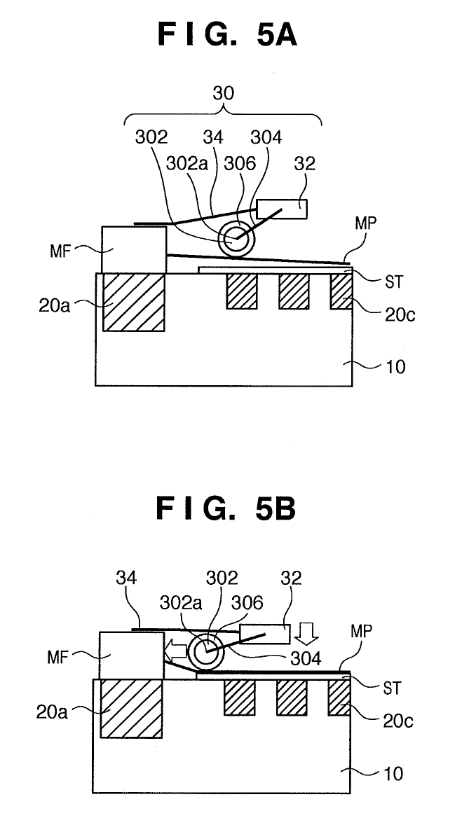

The pressing unit 30 may include the to-be-attracted portion 32, the elastic member 34, a roller 302, and a connecting member 304, as shown in FIGS. 5A and 5B. FIGS. 5A and 5B are enlarged views which show another arrangement of the pressing unit 30 of the holding mechanism 1, and show the pressing unit 30 and its vicinity.

The elastic member 34 which connects the to-be-attracted portion 32 and the mask frame MF supports the to-be-attracted portion 32 while it is spaced apart from the mask pattern MP. Also, the connecting member 304 is pivotally supported by the mask frame MF, and connects the to-be-attracted portion 32 and the roller 302 (and, more specifically, a rotation shaft 302a of the roller 302), thereby supporting the roller 302 to be rotatable about the rotation shaft 302a as a center. In this embodiment, the connecting member 304 is pivotable about a connecting point, at which it connects to the to-be-attracted portion 32, as a center. Also, the connecting member 304 supports the roller 302 so that the roller 302 moves from the center of the mask pattern MP toward the peripheral portion of the mask pattern MP while pressing the mask pattern MP toward the base 10 as the permanent electromagnets 20c magnetically attract the to-be-attracted portion 32.

The roller 302 can be made of either a magnetic material or a nonmagnetic material. Note, however, that if the roller 302 is made of a magnetic material, the magnetic attraction force of the permanent electromagnets 20c for the roller 302 must be smaller than that of the permanent electromagnets 20c for the to-be-attracted portion 32. This makes it possible to prevent the roller 302 from being magnetically attracted by the permanent electromagnets 20c in excess of a threshold beyond which the roller 302 cannot move on the mask pattern MP.

Also, the roller 302 includes, on its contact surface that comes into contact with the mask pattern MP, a protective member 306 which protects the mask pattern MP. The protective member 306 is made of, for example, a rubber sheet and prevents the mask pattern MP from damaging due to an impact as the roller 302 presses the mask pattern MP.

The detailed operation of the pressing unit 30 shown in FIGS. 5A and 5B will be explained. FIG. 5A shows a state before the to-be-attracted portion 32 of the pressing unit 30 is magnetically attracted, that is, a state in which the permanent electromagnets 20a magnetically attract the mask frame MF, and the permanent electromagnets 20b magnetically attract the central portion of the mask pattern MP. In the state shown in FIG. 5A, the permanent electromagnets 20c for magnetically attracting the peripheral portion of the mask pattern MP are inactive (i.e., they are not supplied with a current), and therefore do not magnetically attract the peripheral portion of the mask pattern MP. Accordingly, the peripheral portions of the substrate ST and mask pattern MP are spaced apart from each other. The mask pattern MP and the roller 302 (protective member 306) are also spaced apart from each other by the elastic member 34 which connects the mask frame MF and the to-be-attracted portion 32, and the connecting member 304 which connects the elastic member 34 and the roller 302.

In the state shown in FIG. 5A, as the permanent electromagnets 20c are activated upon receiving a current, they magnetically attract the to-be-attracted portion 32 and the peripheral portion of the mask pattern MP. With this operation, the peripheral portion of the mask pattern MP presses the substrate ST toward the base 10, and the to-be-attracted portion 32 is attracted toward the base 10, as shown in FIG. 5B. At this time, the force which attracts the to-be-attracted portion 32 toward the base 10 is transmitted to the roller 302 through the connecting member 304. When this takes place, the roller 302 moves from the center of the mask pattern MP toward the peripheral portion of the mask pattern MP while pressing the peripheral portion of the mask pattern MP toward the base 10. This makes it possible to satisfactorily fix the substrate ST on the base 10. It is also possible to bring the mask pattern MP into tight contact with the substrate ST while extending the peripheral portion of the mask pattern MP (i.e., while removing any flexure and wrinkles of the mask MS). Consequently, a given precision of a pattern formed on the substrate ST, for example, can be maintained free from any positional error of the substrate ST attributed to acceleration/deceleration even upon transporting the holding mechanism 1 which holds (fixes) the substrate ST and the mask MS.

To cancel the holding (fixing) of the substrate ST and mask MS by the holding mechanism 1, it is only necessary to perform the foregoing operation in reverse order. More specifically, while the base-side contacts 40 and the power-supply-side contacts 510 are connected to each other, the switches 520c, 520b, and 520a are sequentially energized to supply a current to the permanent electromagnets 20c, 20b, and 20a, respectively. This cancels the magnetic attraction for the to-be-attracted portion 32 and the peripheral portion of the mask pattern MP by the permanent electromagnets 20c, that for the central portion of the mask pattern MP by the permanent electromagnets 20b, and that for the mask frame MF by the permanent electromagnets 20a. In this way, the holding (fixing) of the substrate ST and mask MS by the holding mechanism 1 can be canceled.

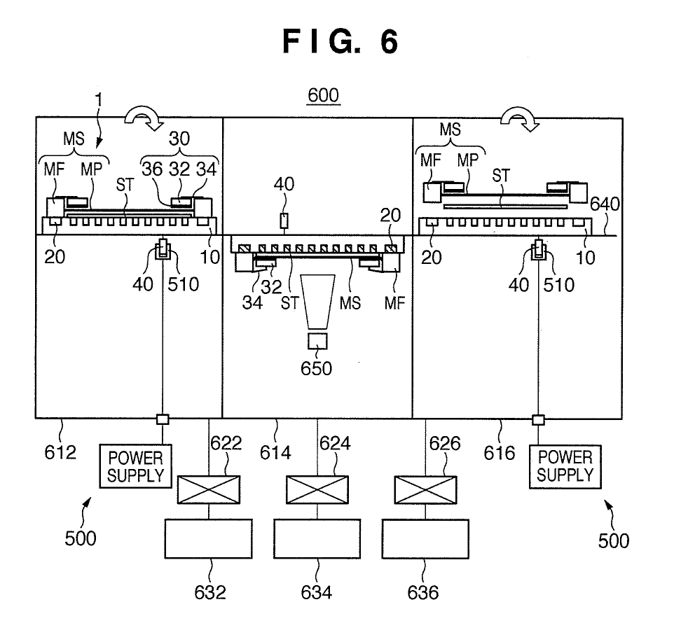

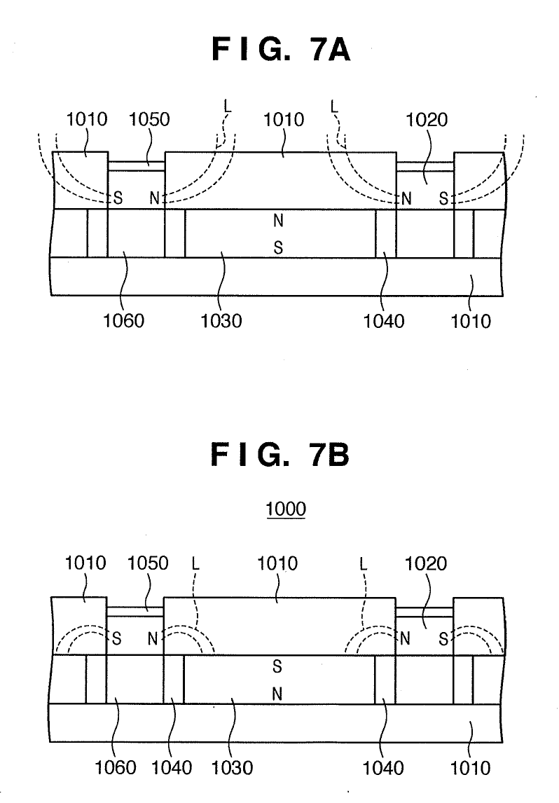

A deposition method using a processing apparatus according to the present invention will be explained below. FIG. 6 is a schematic view showing a deposition process using a processing apparatus 600 according to the present invention. The processing apparatus 600 adopts the in-line scheme or the inter-back scheme and forms a pattern on a substrate ST as a processing object by, for example, depositing a material on the substrate ST.

The processing apparatus 600 includes a plurality of chambers: a loading chamber 612, processing chamber 614, and unloading chamber 616 in this embodiment. The loading chamber 612, processing chamber 614, and unloading chamber 616 are respectively connected to vacuum exhaust units 632, 634, and 636 including, for example, vacuum pumps through valves 622, 624, and 626. Each of the loading chamber 612 and the unloading chamber 616 includes a power feed system 500 for activating permanent electromagnets 20 of a holding mechanism 1.

First, a process for aligning a substrate ST and a mask MS and holding them by the holding mechanism 1 is performed in the loading chamber 612. The substrate ST and the mask MS including a mask pattern MP and mask frame MF are loaded into the loading chamber 612 through a transport mechanism (not shown). The holding mechanism 1 placed in the loading chamber 612 holds (fixes), by magnetic attraction, the substrate ST and mask MS loaded into the loading chamber 612. The holding (fixing) of the substrate ST and mask MS by the holding mechanism 1 is the same as that described above, and a detailed description thereof will not be given herein. A transport unit 640 including, for example, a transport roller transports the holding mechanism 1 holding (fixing) the substrate ST and the mask MS to the processing chamber 614. At this time, the transport unit 640 turns the holding mechanism 1 upside down.

Next, a processing unit processes the substrate ST held by the holding mechanism 1 in the processing chamber 614. In this embodiment, the processing unit forms a pattern (thin-film pattern) on the substrate ST by depositing a material from a deposition source 650 on the substrate ST through the mask MS. More specifically, a pattern corresponding to the opening of the mask MS is formed on the substrate ST by placing the pattern formation surface of the substrate ST face-down so that this surface faces the deposition source 650, and heating the deposition source 650. After the deposition process is completed, the transport unit 640 transports the holding mechanism 1 holding (fixing) the substrate ST and the mask MS to the unloading chamber 616. At this time, the transport unit 640 turns the holding mechanism 1 upside down.

Lastly, a process for canceling the holding (fixing) of the substrate ST and mask MS by the holding mechanism 1 is performed in the unloading chamber 616. The cancellation of the holding (fixing) of the substrate ST and mask MS by the holding mechanism 1 is the same as that described above, and a detailed description thereof will not be given herein. The substrate ST and mask MS released from the holding mechanism 1 are unloaded from the unloading chamber 616 through the transport mechanism (not shown).

Since the processing apparatus 600 holds (fixes) the substrate ST and the mask MS by the holding mechanism 1, any positional error of the substrate ST never occurs owing to acceleration/deceleration even upon transporting the holding mechanism 1. Consequently, the processing apparatus 600 can maintain a given precision of a pattern formed on the substrate ST, and can, in turn, form a fine pattern on the substrate ST with high accuracy. Also, since the processing apparatus 600 holds (fixes) the substrate ST by the holding mechanism 1 without using an electrostatic chuck, it can reduce the apparatus cost.

One example of image display devices that are especially suitably manufactured by adopting the above-mentioned deposition method and the processing apparatus according to the present invention is an organic electroluminescent element.

An organic electroluminescent element can emit light beams of light's three primary colors: red, green, and blue by appropriately selecting materials for luminescent layers which constitute parts of the element, and can realize a full-color image display device as a result.

More specifically, the foregoing luminescent portions (portions which emit light beams of red R, green G, and blue B) are formed using a deposition method. In forming, for example, a luminescent portion of red R, luminescent portions of green G and blue B are covered with a mask so as not to mix with the luminescent material of red R. The same mask use method applies to the portions of green G and blue B.

The holding mechanism according to the present invention is not limited to a processing apparatus which forms a pattern using a vacuum deposition method, and is usable for processing apparatuses which form patterns using, for example, a sputtering method and a chemical vapor deposition method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-255178 filed on Sep. 30, 2008, which is hereby incorporated by reference herein in its entirety.

What is claimed is:

1. A holding mechanism which holds a processing object and a mask including a mask pattern located on the processing object, and a mask frame which supports the mask pattern in a periphery thereof, the mechanism comprising:
a base configured to hold, on a holding surface thereof, the processing object and the mask frame;
a permanent magnet, arranged along the holding surface of said base, configured to fix the processing object and the mask on said base by magnetically attracting the mask; and
a pressing unit which is located on a peripheral portion of the mask pattern, includes a to-be-attracted portion magnetically attracted by said permanent magnet, and is configured to press the peripheral portion of the mask pattern toward said base as said permanent magnet magnetically attracts said to-be-attracted portion.

2. The mechanism according to claim 1, wherein said pressing unit is connected to the mask frame through an elastic member made of a nonmagnetic material.

3. The mechanism according to claim 1, wherein said to-be-attracted portion includes, on a contact surface thereof that comes into contact with the mask pattern, a protective member configured to protect the mask pattern.

4. The mechanism according to claim 1, wherein said to-be-attracted portion is configured such that a magnetic attraction force of said permanent magnet for said to-be-attracted portion is larger than a magnetic attraction force of said permanent magnet for the mask pattern.

5. The mechanism according to claim 1, wherein said pressing unit includes
an elastic member configured to support said to-be-attracted portion while said to-be-attracted portion is spaced apart from the mask pattern,
a roller, and
a connecting member which is pivotally supported by the mask frame, and configured to connect said to-be-attracted portion and said roller and to support said roller so that said roller moves from the center of the mask pattern toward the peripheral portion of the mask pattern while pressing the mask pattern toward said base as said permanent magnet magnetically attracts said to-be-attracted portion.

6. The mechanism according to claim 5, wherein said roller includes, on a contact surface thereof that comes into contact with the mask pattern, a protective member configured to protect the mask pattern.

7. The mechanism according to claim 5, wherein said roller is made of a magnetic material and is configured such that a magnetic attraction force of said permanent magnet for said roller is smaller than a magnetic attraction force of said permanent magnet for said to-be-attracted portion.

8. The mechanism according to claim 5, wherein said roller is made of a nonmagnetic material.

9. A processing apparatus comprising:
a holding mechanism configured to hold a processing object and a mask including a mask pattern located on the processing object, and a mask frame which supports the mask pattern in a periphery thereof;
a processing unit configured to process the processing object through the mask; and
a transport unit configured to transport said holding mechanism to said processing unit,
wherein said holding mechanism includes a holding mechanism defined in claim 1.

10. The apparatus according to claim 9, wherein said processing unit includes a vacuum exhaust unit, and performs a deposition process for depositing a material on the processing object.

11. The apparatus according to claim 10, wherein said transport unit turns upside down said holding mechanism configured to hold the processing object and the mask.

12. A deposition method comprising forming a thin film on a processing object using a processing apparatus defined in claim 10.

13. A method of manufacturing an image display device, the method comprising manufacturing a luminescent portion from the processing object having the thin film formed using a deposition method defined in claim 12.
